(19) United States
(12) Patent Application Publication
(10) Pub. No.: US 2023/0222217 A1
(43) Pub. Date: Jul. 13, 2023

(54) ADAPTIVE INTEGRITY LEVELS IN ELECTRONIC AND PROGRAMMABLE LOGIC SYSTEMS

(71) Applicant: XILINX, INC., San Jose, CA (US)

(72) Inventor: Jaideep DASTIDAR, San Jose, CA (US)

(21) Appl. No.: 17/571,288

(22) Filed: Jan. 7, 2022

(51) Int. Cl. G06F 21/57

(52) U.S. Cl. CPC G06F 21/57; G06F 2221/034

(57) ABSTRACT

Methods and apparatus for adaptive integrity levels in electronic and programmable logic systems. In one example, an interface for communication between a first component and a second component is provided. The interface includes logic configured to change an integrity level for a communication from the first component to the second component during operation of the first component and the second component.

### TECHNICAL FIELD

Examples of the present disclosure generally relate to integrity levels in electronic systems, and more particularly, to components interacting with other components at varying integrity levels, where at least one of the components can effectively change its integrity level for an interaction with another one of the components.

### BACKGROUND

Electronic systems, programmable systems (e.g., central processing units (CPUs)), and programmable logic (PL)-based systems can be used in various data processing environments. Systems of these types may handle different types of communication protocols, such as communication protocols for data transfers between an integrated circuit (IC) and a memory separate from the IC (for example, an external memory) and communication protocols between components within a system. Data transferred between an IC and an external memory may correspond to data transferred by an application executed by or operating on the IC to the external memory where data associated with the application is stored. Communication protocols between components within a system may correspond to transactions and messages for maintaining the coherence of instruction and/or data caches of those components.

However, communication protocols (both the communication protocols between an IC and an external memory and the communication protocols between components of a system) can experience errors that result in operational errors in the component, data corruption, or other data accuracy issues or that indicate data security issues. In some instances, detection of such errors is critical to maintaining safety and operation of high-reliability applications. For example, in functional safety applications, accuracy of these communication protocols is crucial. The communication errors and data corruption can be introduced by various causes, such as transient errors, permanent faults in logic or memory elements along the communication path, cybersecurity attacks, and the like.

However low a probability of such errors, certain standards mandate that corresponding devices implement mechanisms to ensure communication accuracy, safety, and/or security and to detect communication errors and data corruption between source and sink points. These mechanisms may involve communication protocols using different integrity levels, ranging from no integrity checking, to parity or error correction code (ECC) checks, to double, triple, and higher levels of redundant communication channels. Detection of such corruption of information transferred over the communication channels may be detected by integrity level checks. Integrity level checks may involve eliminating or reducing the risk of failures, detecting failures in a predictable manner, or gracefully reacting to failures in a predictable manner. These integrity level checks may check the integrity of internal functions of electronic, programmable, and/or PL components in a system and/or check the integrity of communication between components, which can be homogeneous components (e.g., multiple application specific integrated circuit (ASIC) components) or heterogeneous components (e.g., data processing engines (e.g., for artificial intelligence) and PL fabric components).

Unfortunately, such integrity level checks often include redundant processing, communication, and data paths, which can result in reduced performance and/or increased resource usage and corresponding costs. Improved data accuracy mechanisms are therefore desired.

### SUMMARY

Examples described herein generally relate to interfaces between system components and methods that select and/or change integrity level of a communication between system components. Thus, the techniques described herein enable integrity level checking of communication messages, including data transfers, between components having different integrity level checking capabilities.

In one example, an interface for communication between a first component and a second component is provided. The interface includes logic that is configured to change an integrity level for a communication from the first component to the second component during operation of the first component and the second component.

In another example, an integrated circuit (IC) is provided that includes an interface for communication between a first component coupled to the interface and a second component coupled to the interface, wherein the interface comprises a communication hub. The interface includes logic that is configured to change an integrity level for a communication from the first component to the second component during operation of the first component and the second component.

In yet another example, a method of communication is provided. The method includes determining a first integrity level of a first component; determining a second integrity level of a second component; selecting, at an interface between the first component and the second component, an integrity level for a first communication from the first component to the second component, based on the first integrity level and the second integrity level; and sending the first communication through the interface, from the first component to the second component, according to the integrity level for the first communication.

These and other aspects may be understood with reference to the following detailed description.

### BRIEF DESCRIPTION OF THE DRAWINGS

So that the manner in which the above-recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 shows an automobile with various sensors and advanced driver-assistance systems (ADAS), in which examples of the present disclosure may be practiced.

FIG. 2 shows a block diagram of components of a system that implements integrity level checking, in which examples of the present disclosure may be practiced.

FIGS. 3A and 3B show block diagrams of a system, in accordance with an example of the present disclosure.

FIGS. 4A-4D show block diagrams of operations of an integrity level converter, in accordance with examples of the present disclosure.

FIG. 5 shows an example communication hub with an integrity level converter implementing adaptive integrity levels, supporting various integrity classes, and facilitating communications between two components, in accordance with an example of the present disclosure.

FIG. 6 shows example operations by the integrity level converter of FIG. 5, in accordance with an example of the present disclosure.

FIG. 7 shows an example system including an example adaptive integrity level hub, in accordance with an example of the present disclosure.

FIG. 8 depicts a flowchart of a method of communicating by components in a system, in accordance with an example of the present disclosure.

To facilitate understanding, identical reference numerals have been used, where possible, to designate identical elements that are common to the figures. It is contemplated that elements of one example may be beneficially incorporated in other examples.

### DETAILED DESCRIPTION

Examples of the present disclosure provide methods and apparatus for implementing adaptive integrity levels in electronic and programmable logic systems. In this manner, various components (some with fixed integrity levels and others with adaptive integrity levels) can communicate with each other at varying integrity levels. The integrity levels may vary depending on changing features of an application with time and/or space. Furthermore, with adaptive integrity levels, a portion of resources can be redeployed to lower integrity level applications when one or more components change from a higher integrity level to a lower integrity level.

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the claimed invention or as a limitation on the scope of the claimed invention. In addition, an illustrated example need not have all the aspects or advantages shown. An aspect or an advantage described in conjunction with a particular example is not necessarily limited to that example and can be practiced in any other examples even if not so illustrated or if not so explicitly described. Further, methods described herein may be described in a particular order of operations, but other methods according to other examples may be implemented in various other orders (e.g., including different serial or parallel performance of various operations) with more or fewer operations.

In the description that follows, the term “integrity level checks” refers to functions performed to verify the integrity of internal functions of electronic, programmable, and programmable logic (PL) components in a system, as well as checking the integrity of communication between components. Integrity level checks may range from low levels of integrity checks to higher levels of integrity checks. Low levels of integrity checks may consume fewer resources, less power, and potentially enable higher levels of performance of a component for a given resource footprint. Examples of lower levels of integrity checks include error detection of coalesced signals or state, such as parity checks, error correction code (ECC), and cyclic redundancy checks (CRCs). Depending on the desired level of integrity checks, parity, ECC, or CRC may be applied over a coalesced logical group of signals, such as request and response signals, or coalesced across all available signals, such as request, response, and data, in a communication protocol. State integrity checks can involve CRC or secure hash algorithms (SHAs) calculated over a coalesced logical group of registers (e.g., registers within components or coalesced key register values across components, such as key routing table registers across components). Higher levels of integrity checks may consume significantly higher resources, increasing power consumption and potentially lowering performance levels for the same resource footprint, compared to lower levels of integrity checks. Examples of higher levels of integrity checks include redundant signals and/or state of a component. For example, double redundancy for signals or state significantly increases error detection capability of a component, and triple or higher redundancy not only increases the error detection capability, but also significantly reduces the risk of failure and improves the ability of the component or system to gracefully react to failures.

Computing systems and devices include components that can be used in various applications or situations, some of which may be safety and/or data critical situations, such as in one or more of the automotive, industrial, aerospace, defense, or similar industries. The components may be heterogeneous, such as a mix of programmable logic (PL) fabric, processing subsystems (PSs), or offload accelerators (e.g., image sensor processors (ISPs) or data processing engines, such as for artificial intelligence). The heterogeneous components may interact with each other at varying integrity levels while collectively performing heterogeneous functions. That is, each component may check at least one of messages, state, or data received from other components and its own functions at an integrity level that is independent of integrity level checks performed by the other components.

Error detection of coalesced signals or state may be applied to functions within a component, direct communication between components, and/or a communication hub connecting multiple components.

Techniques to achieve high integrity levels, such as redundancy, may be used both for functional safety considerations and for security considerations. For example, integrity checks in redundant components can flag physical intrusion attacks, such as attempts to steal cryptographic secrets using voltage glitch attacks.

Due to the significant impact (resources, power, and performance) of providing high integrity levels to components and communication hubs between components, current techniques involve making tradeoffs between overall performance and achieved integrity levels at the time of system design and implementation. Once implemented, very little can be done to alter the tradeoff decisions made during implementation. Thus, an implementation that is targeted at high integrity level functions and applications will typically consume more resources and power than an implementation targeted at low integrity level functions. Similarly, implementations that are constrained by resource limitations and/or power consumption limitations will be limited to low integrity level functions and applications. However, many systems are heterogeneous, wherein domain-specific components are interconnected such that functions best performed in the software domain are serviced by processing components, functions best performed in the application-specific integrated circuit (ASIC) domain are serviced by ASIC-like components, artificial intelligence (Al) functions are serviced by machine learning (ML) accelerators such as graphic processor units (GPUs), math engines, or tensor processors, and functions or acceleration that require adaptability are serviced by programmable logic components. In such heterogeneous systems, the tradeoff of integrity level versus resources/power may be constrained such that the system implements either: (1) the lowest integrity level of the integrity levels across all heterogeneous components (e.g., depending on the type of computation or the type of application specific to the components) or (2) the integrity level of an integrated processor (IP, such as provided by a third party) having a fixed integrity level and dictating that all components communicate with that IP at a higher integrity level than would have otherwise been selected for the system.

Furthermore, although different applications may call for different integrity levels to be built into their components, frequently, computation data (e.g., sensor data) may be common to the different applications but computed differently (e.g. different sensor fusion functions) and at different integrity levels. For example, in an automotive deployment, applications may involve a common subset of sensors, but the level of computations and the integrity levels of each computation can vary.

Thus, the current approach of an implementation being anchored to an integrity level has the disadvantage that to target different integrity levels entails different implementations of a system. Otherwise, the sunk cost of a higher integrity level must be accepted in order to re-use the same implementation for an application requiring lower integrity levels. Also, there are cases where the data being processed is common and is processed for different applications (with different integrity levels) using a common set of components. If cost or resource usage is prioritized, and it is only the integrity level that varies during computation, unique designs are traditionally implemented to target a set of applications.

The present disclosure provides apparatus and techniques in which various components can communicate with each other at varying integrity levels (e.g., integrity levels that can be effectively and programmatically changed). Some of the components may be designed to a fixed integrity level, and other components may be designed to use adaptive integrity levels (also referred to as programmable integrity levels) that can change. The integrity levels can be adjusted with changing (e.g., varying over time and/or space) demands of an application. Examples of the present disclosure can be used in any of various suitable applications. For example, examples of the present disclosure can be implemented in an automobile to provide higher integrity levels while the automobile is being automatically controlled or driven at higher speeds and lower integrity levels while the automobile is being parked. The integrity levels can also be adjusted with demands of the application that vary with space. For example, two instances of the same implementation can be used in an automobile to provide different integrity levels at two different locations. The techniques provided in the present disclosure apply equally to a communication hub that can adapt to multiple source components with varying integrity levels communicating with a destination component that has the same or different integrity level capability than the source components.

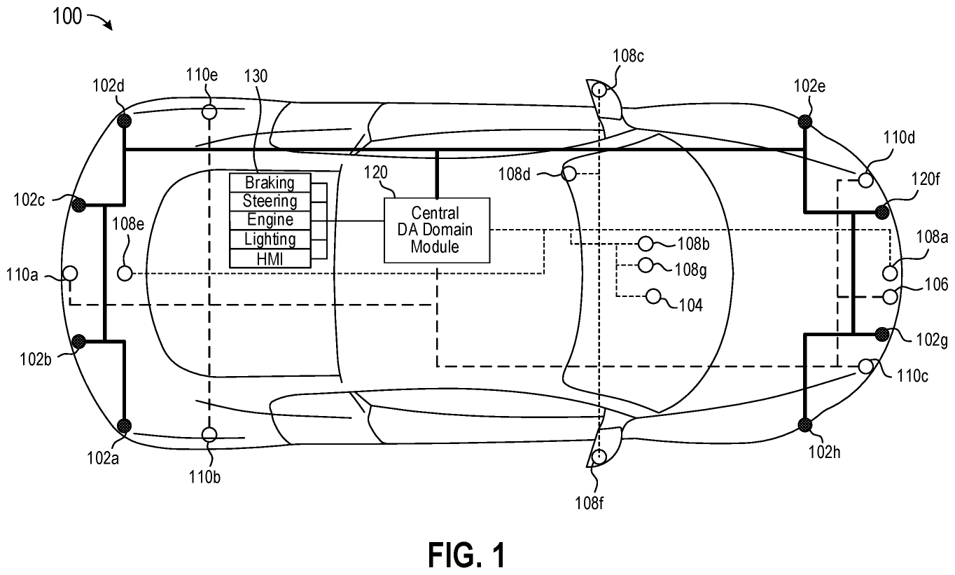

An advantage of the techniques described herein is that a single implementation may target different integrity levels. Depending on the implementation, a portion or all of the resources deployed to achieve higher integrity levels can be redeployed for other functions in an application demanding lower integrity levels. Another advantage of the techniques described herein is that a common implementation using a common set of components may perform at various integrity levels, depending on the application for which computation is being performed. This may enable an implementation to perform at a first integrity level in a first deployment (e.g., a luxury automobile), and the same implementation may perform at a second integrity level in a second deployment (e.g., an entry-level automobile). Another advantage of the techniques described herein is that a safety qualification and certification process (or security qualification and certification process) can be performed on the same implementation by adapting/varying the integrity level of the components and communication between components as such an adaptive integrity level system is evaluated for various qualification and certification criteria. By varying the integrity level of the components during qualification and certification, a system can be qualified or certified for multiple implementations in a single certification or qualification process. Thus, the techniques described herein enable components to be adaptive across integrity levels, improve power efficiency, and improve security so that the resultant device can not only scale up in performance or functionality with more resources being made available for applications demanding lower integrity levels (e.g., lower safety and/or security), but also scale up in the level of functional safety and/or level of security offered by deploying more resources towards achieving higher integrity levels. Further details are provided below with respect to FIGS. 1-8.

FIG. 1 shows an automobile 100 with various sensors and advanced driver-assistance systems (ADASs), in accordance with an example of the present disclosure. The sensors include ultrasonic sensors 102a-102h, thermal/infrared camera 104, laser radar 106, cameras 108a-108g, and short-range radars 110a-110e. A central driver assistance (DA) module 120 may implement various ADASs, such as a lane-departure warning system, a self-parking system, a lane-change assist system, and/or an autonomous driving system. In implementing the various ADASs, the central DA module 120 may implement integrity levels 1, 2, 3, 4, and 5, which correspond to no integrity checking, an Automotive Safety Integrity Level (ASIL) A, ASIL B, ASIL C, and ASIL D, respectively

The central DA module 120 may send output commands regarding braking, steering, engine output, lighting, and/or a human-machine interface (HMI) to a vehicle control module 130. The central DA module 120 may use data from the front cameras 108a, 108b, and 108g to implement the lane-departure warning system. The central DA module 120 may implement the lane-departure warning system at an integrity level of 1 or 2. The central DA module 120 may use data from the cameras 108a, 108c, 108e, 108f, short-range radars 110a-110e, and ultrasonic sensors 102a-102h to implement the self-parking system. The central DA module 120 may implement the self-parking system at an integrity level of 3. The central DA module 120 may use data from the cameras 108a, 108c, 108e, and 108f and short-range radars 110a-110e to implement the lane-change assist system. The central DA module 120 may implement the lane-change assist system at an integrity level of 3. The central DA module 120 may use data from the ultrasonic sensors 102a-102h, thermal/infrared camera 104, laser radar 106, cameras 108a-108g, and short-range radars 110a-110e to implement the autonomous driving system. The central DA module 120 may further implement a machine learning (e.g., deep learning) system with the autonomous driving system, and the central DA module 120 may implement the autonomous driving system at an integrity level of 4 or 5.

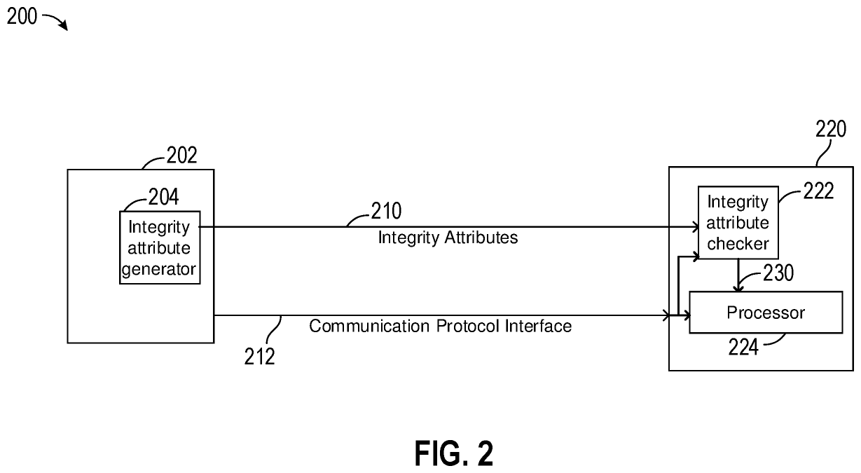

FIG. 2 shows a block diagram of components 202 and 220 of a system 200 that implements integrity level checking, in accordance with an example of the present disclosure. Component 202 may be, for example, a sensor, a processor, ASIC, PL fabric, memory, network interface card, data storage device, or any other device configured to deliver communication protocol information (e.g. messages, interrupts, or data), henceforth referred to as “data,” to component 220. Component 220 may be, for example, a DA module, a vehicle control module, a processor, ASIC, PL fabric, memory, network interface card, data storage device, a logger, or any other device configured to receive data from component 202. The component 220 receives data via a communication protocol interface 212 from the component 202. For example, the component 220 may be the central DA module 120 shown in FIG. 1, and the component 202 may be the camera 108a, also shown in FIG. 1. As an example, the system 200 may operate at integrity level 2. For example, the component 220 may check that an integrity attribute (e.g., a CRC) of data supplied via the communication protocol interface 212 matches a supplied integrity attribute 210.

When supplying the data via the communication protocol interface 212 to the component 220, the component 202 generates one or more integrity attributes 210 using an integrity attribute generator function 204. The component 202 transmits the integrity attributes 210 in association with the data. The component 220 receives the integrity attribute(s) 210 and the data and verifies the data with the supplied integrity attribute(s) 210 using an integrity attribute checker function 222. When the supplied data has passed integrity attribute checks, the integrity attribute checker function 222 sends an indication 230 (e.g., sets a flag in memory or sends an electronic signal) to a processor function 224. When the processor function 224 obtains the indication 230, the processor function 224 then processes the supplied data 212. If the data 212 fails the integrity attribute checks performed by the integrity attribute checker function 222, then the integrity attribute checker function 222, the processor function 224, or an error-checking function in component 220 may generate an error message or otherwise indicate an error to preserve the integrity level.

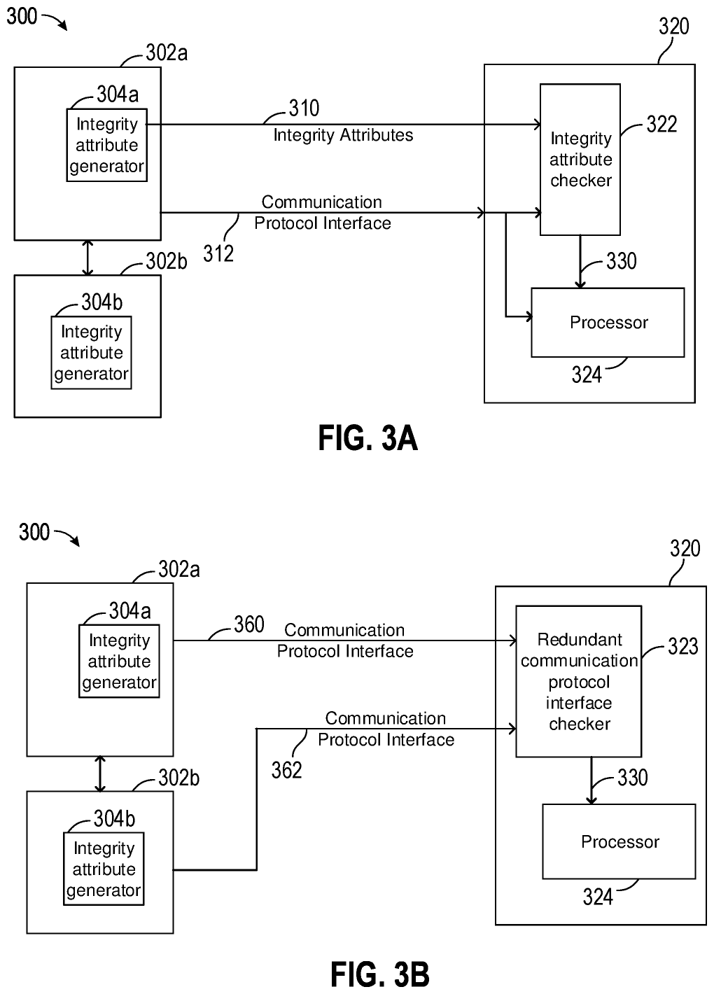

FIGS. 3A and 3B show block diagrams of a system 300, in accordance with examples of the present disclosure. The system 300 includes redundant components 302a and 302b (e.g., a pair of image sensor processors set up in a mirrored configuration) and a component 320. Components 302a and 302b may be, for example, a pair (or more) of sensors, processors, ASICs, PL fabrics, memory banks, network interface cards, data storage devices, or any other redundant devices configured to deliver data to component 320. Component 320 may be, for example, a DA module, a vehicle control module, a processor, ASIC, PL fabric, memory, network interface card, data storage device, a logger, or any other device configured to receive data from components 302a and 302b. In FIG. 3A, the system 300 may be operating at integrity level 2 or 3, for example.

When supplying data via a communication protocol interface 312 to the component 320, the component 302a generates one or more integrity attributes using an integrity attribute generator function 304a. The component 302a transmits the integrity attributes 310 in association with the data. The component 320 receives the integrity attributes 310 and the data and verifies the data with the supplied integrity attributes 310 using an integrity attribute checker function 322. When the supplied data has passed integrity attribute checks, the integrity attribute checker function 322 sends an indication 330 (e.g., sets a flag in memory or sends an electronic signal) to a processor function 324. When the processor function 324 obtains the indication 330, the processor function 324 then processes the data supplied via the communication protocol interface 312. If the data fails integrity attribute checks performed by the integrity attribute checker function 322, then the integrity attribute checker function 322, the processor function 324, or an error-checking function in component 320 may generate an error message or otherwise indicate an error to preserve the integrity level.

In FIG. 3B, the system 300 may be operating at a higher integrity level, such as integrity level 4. The redundant component 302a supplies a first copy of data via a communication protocol interface 360 to the component 320, and the redundant component 302b supplies a second copy of the same data via a communication protocol interface 362 to the component 320. The component 302a transmits the first copy of the data via the communication protocol interface 360 in association with the component 302b transmitting the second copy of the data via the communication protocol interface 362. The component 320 receives the first copy of the data and the second copy of the data and verifies that the first copy of the data matches the second copy of the data using a redundant communication protocol interface checker function 323.

The redundant communication protocol interface checker function 323 and the integrity attribute checker function 322 (see FIG. 3A) may be implemented as separate functions or as subroutines within a data integrity checking function (not shown). The redundant communication protocol interface checker function 323 and the integrity attribute checker function 322 (see FIG. 3A) may also be implemented as reconfigured programmable logic (PL) blocks with the option of saving PL resources when the PL blocks are configured as the integrity attribute checker function 322 and consuming more PL resources when the PL blocks are configured as a redundant communication protocol interface checker function 323. When the redundant communication protocol interface checker function 323 has verified that the first copy of the data matches the second copy of the data, the redundant communication protocol interface checker function 323 sends a copy of the data and/or an indication 330 (e.g., sets a flag in memory or sends an electronic signal) to the processor function 324. When the processor function 324 obtains the data or the indication 330, the processor function 324 then processes the data. If redundant communication protocol interface checker function 323 does not verify that the first copy of the data matches the second copy of the data, then the redundant communication protocol interface checker function 323 or an error-checking function in component 320 may indicate an error to preserve the integrity level.

In another example of the present disclosure, for higher integrity levels, such as integrity level 5, the system 300 may be operating with triple redundant integrity attributes. For that example, a third redundant component (not shown) supplies a third copy of the same data via another communication protocol interface (not shown) to the component 320. If the data has passed integrity attribute checks performed by the redundant communication protocol interface checker function 323 across one but not both redundant channels, then the redundant communication protocol interface checker function 323, the processor function 324, or an error-checking function in component 320 may indicate an error of lower severity, such that the processor function 324 may continue to process the supplied data from the two redundant communication protocol interfaces 360 and 362 that passed the integrity attribute checks.

In an example of the present disclosure, a system may implement integrity level converters to facilitate integrity level communication that is compatible between components. That is, if two components support different integrity levels, then an integrity level converter may be implemented to enable the two components to send and receive data from each other, and each component is able to verify the integrity of data received from the other component. For example, if a component sending data (referred to herein as a “send component”) determines integrity attributes based on all coalesced signals and the component receiving the data (referred to herein as a “receive component”) determines integrity attributes based on only the send/receive data subset, then a send integrity level converter may terminate the integrity attributes of all non-data-request signals and connect the integrity attributes of all data signals. Meanwhile, a receive integrity level converter may generate the integrity attributes of all non-data request signals and connect the integrity attributes of all data signals. In another example, if the send component is an integrity level 2 component that has parity integrity attributes determined based on each of the coalesced request, request data, response, and response data logical groups of signals, and the receive component is an integrity level 3 component that determines ECC integrity attributes based on each of the coalesced request, request data, response, and response data logical groups of signals, then the send integrity level converter may convert the parity integrity attributes of the send component to ECC integrity attributes for compatibility of communication with the integrity level 3 receive component Meanwhile, the receive integrity level converter will do the opposite, which is to convert the ECC integrity attributes of the integrity level 3 receive component to parity attributes in the response path to the integrity level 2 send component.

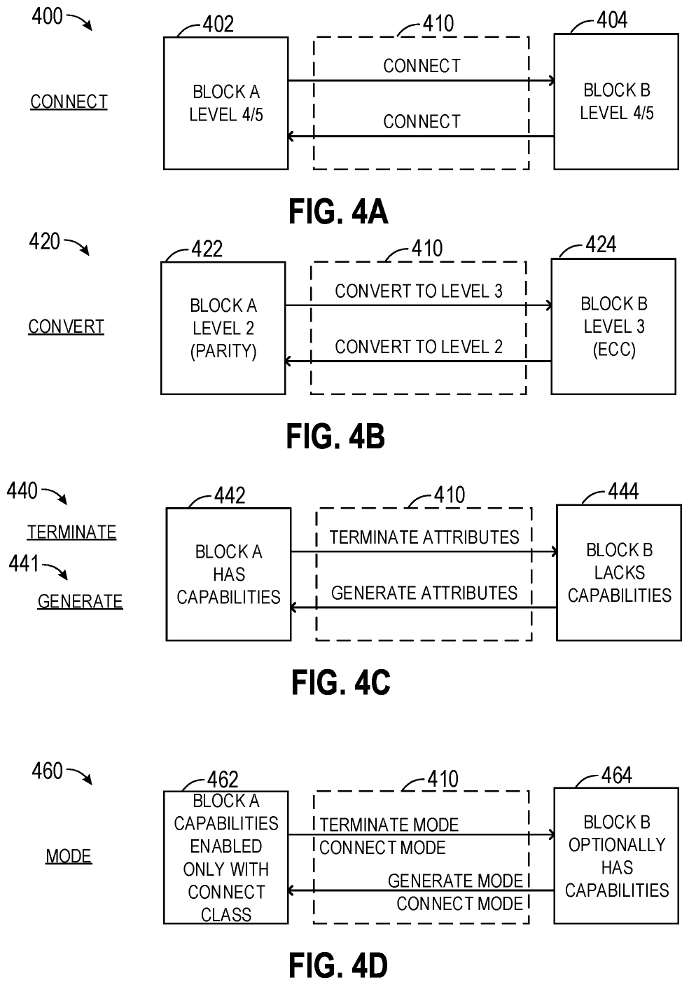

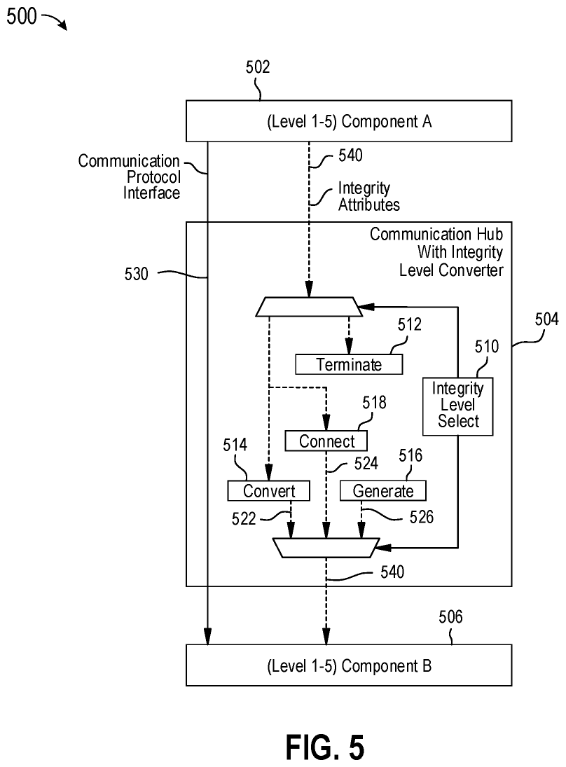

FIGS. 4A-4D show block diagrams of example modes of operation of an integrity level converter 410, in accordance with examples of the present disclosure. As described herein, the integrity level converter 410 is an interface acting between two blocks, Block A and Block B, and may comprise functions built into either or both of the Blocks A and B or into a communication hub, as described in FIGS. 5-7, and so the integrity level converter is represented by dashed lines. Blocks A and B may be physical components (e.g., ASICs or PL fabric) or logical functions built into one component (e.g., logical functions in a system on a chip (SoC)). The modes of operations of the integrity level converter 410 may include a Connect, Convert, Generate, Terminate, or Mode integrity class, which are described below.

FIG. 4A shows the integrity level converter 410 implementing a Connect integrity class 400. A Connect integrity class between two blocks describes a mode where both blocks have an exact match of integrity levels, including error protection, propagation, detection, and reporting capabilities, and therefore, also an exact match of signals on the send/receive interfaces of each block. In the example shown in FIG. 4A, Block A 402 operates at integrity level 4 or integrity level 5, and Block B 404 operates at the same integrity level. The integrity level converter 410 determines that Block A 402 and Block B 404 are operating at the same integrity level. The integrity level converter 410 connects the integrity attributes of Block A 402 to the integrity attributes of Block B 404 for communications from Block A 402 to Block B 404. Similarly, the integrity level converter 410 connects the integrity attributes of Block B 404 to the integrity attributes of Block A 402 for communications from Block B 404 to Block A 402.

FIG. 4B shows the integrity level converter 410 implementing a Convert integrity class 420. A Convert integrity class between two Blocks A and B describes a mode where either: (1) Block A has a subset of the error protection, propagation, detection, and reporting capabilities of Block B or (2) Block A has a different error protection, propagation, and/or detection method than Block B. An example of Block A having a subset of the capabilities of Block B may be that Block A has datapath protection, but lacks having both the control and datapath protection capabilities of Block B. An example of Block A having a different error protection, propagation, and/or detection method than Block B may include Block A having parity protection, whereas Block B has ECC protection. Another example of Block A having a different error protection, propagation, and/or detection method than Block B may be that Block A has a fully redundant set of signals with integrity checks across all redundant pairs of signals, whereas Block B only has parity or ECC integrity checks for signals or groups of signals.

In the example shown in FIG. 4B, Block A 422 operates at integrity level 2 (e.g., parity checking of data), whereas Block B 424 operates at integrity level 3 (e.g., error correcting code). The integrity level converter 410 determines that Block A 422 is operating at integrity level 2 and Block B 424 is operating at integrity level 3. The integrity level converter 410 converts the integrity level 2 integrity attributes, sent by Block A 422 in communications to Block B 424, into integrity level 3 integrity attributes for delivery to Block B 424. For example, the integrity level converter 410 may remove parity information from the data and may generate error correcting code for the data. Similarly, the integrity level converter 410 converts the integrity level 3 integrity attributes, sent by Block B 424 in communications to Block A 422, into integrity level 2 integrity attributes for delivery to Block A 422. For example, the integrity level converter 410 extracts data from the error correcting code sent by Block B 424 and adds parity information to the data.

FIG. 4C shows the integrity level converter 410 implementing a Terminate integrity class 440 and a Generate integrity class 441. A Generate integrity class 441 between two blocks describes a mode where one block's error protection, propagation, detection, and reporting capabilities are not available at all in its block partner. In a Generate integrity class between two Blocks A and B where Block A has error protection, propagation, detection, and reporting capabilities and Block B does not, Block B has its error protection, propagation, detection, and reporting capabilities generated before sending the traffic to Block A. A Terminate integrity class between two blocks describes a mode wherein one block's error protection, propagation, detection, and reporting capabilities are not available at all in its block partner. In a Terminate integrity class between two Blocks A and B where Block A has error protection, propagation, detection, and reporting capabilities and Block B does not, Block A has its error protection, propagation, detection, and reporting capabilities terminated before sending the traffic to Block B.

In the example shown in FIG. 4C, Block A 442 has certain integrity capabilities, whereas Block B 444 does not. The integrity level converter 410 determines that Block A 442 has the integrity capabilities and Block B 444 does not. The integrity level converter 410 terminates the integrity attributes of Block A 442 for communications from Block A 442 to Block B 444, according to the Terminate integrity class. Similarly, the integrity level converter 410 generates the integrity attributes of Block B 444 for communications from Block B 444 to Block A 442, according to the Generate integrity class.

FIG. 4D shows the integrity level converter 410 implementing a Mode integrity class 460. A Mode integrity class between two Blocks A and B describes an interface where one block (e.g., Block B) optionally has the error protection, propagation, detection, and reporting capabilities of its interface block partner (e.g., Block A), whereas the interface block partner can only be enabled with the Connect integrity class. As a result, a Mode integrity class, depending on the mode enabled, exhibits the properties of one of the Connect, Generate, or Terminate integrity classes. A Mode integrity class between two Blocks A and B may enable a Terminate mode where Block A has its error protection, propagation, detection, and reporting capabilities terminated before sending the traffic to Block B, because Block B, for example, wants to conserve its resources and use those resources for other, non-integrity check functionality. A Mode integrity class between two Blocks A and B may enable a Generate mode where Block B has its error protection, propagation, detection, and reporting capabilities generated before sending the traffic to Block A. A Mode integrity class between two Blocks A and B may enable a Connect mode where both blocks have an exact match of error protection, propagation, detection, and reporting capabilities and, therefore, also an exact match of signals on the send/receive interfaces of each block. Therefore, Block B may utilize its resources for integrity check functionality due to the integrity level of the application Block B wants to achieve. The Mode integrity class can apply to programmable logic (PL) blocks and provides implementation users with the option of saving PL resources by not generating the error protection, propagation, detection, and reporting capabilities, depending on the desired integrity level of the user's application.

In the example shown in FIG. 4D, Block A 462 has particular integrity capabilities enabled only with a Connect integrity class, and Block B 464 optionally has these integrity capabilities. The integrity level converter 410 determines whether Block B 464 is operating with these integrity capabilities. If Block B 464 is operating with these integrity capabilities, the integrity level converter 410 implements a Connect integrity class between Block A 462 and Block B 464 in both directions. If Block B 464 is operating without these integrity capabilities, the integrity level converter 410 implements a Terminate integrity class for communications from Block A 462 to Block B 464 and a Generate integrity class for communications from Block B 464 to Block A 462.

FIG. 5 shows an example system 500 with a Component A 502, a Component B 506, and a communication hub with an example integrity level converter 504, in accordance with an example of the present disclosure. The integrity level converter 504 is capable of implementing adaptive integrity levels and supporting various integrity classes, thereby facilitating communications between Component A 502 and Component B 506. The example communication hub with the integrity level converter 504 obtains data via a main signal path 530 and optional integrity attributes via an integrity path 540 from Component A 502 destined for Component B 506. The example integrity level converter 504 determines the integrity level that Component A 502 and the integrity level that Component B 506 are using. Then, based on those determinations, the integrity level select function 510 selects whether to terminate the integrity attributes with terminate logic 512, to convert the integrity attributes with convert logic 514, to generate integrity attributes with generate logic 516, or to connect the integrity attributes with connect logic 518. If the integrity level select function 510 selects to terminate the integrity attributes, then the communication hub with the integrity level converter 504 delivers the data via the main signal path 530 to Component B 506, but no integrity attributes are delivered via the integrity path 540. If the integrity level select function 510 does not select to terminate the integrity attributes, then the communication hub with the integrity level converter 504 delivers the converted integrity attributes 522, the connected integrity attributes 524, or the generated integrity attributes 526 (via the integrity path 540) with the data (via the main signal path 530) to Component B 506.

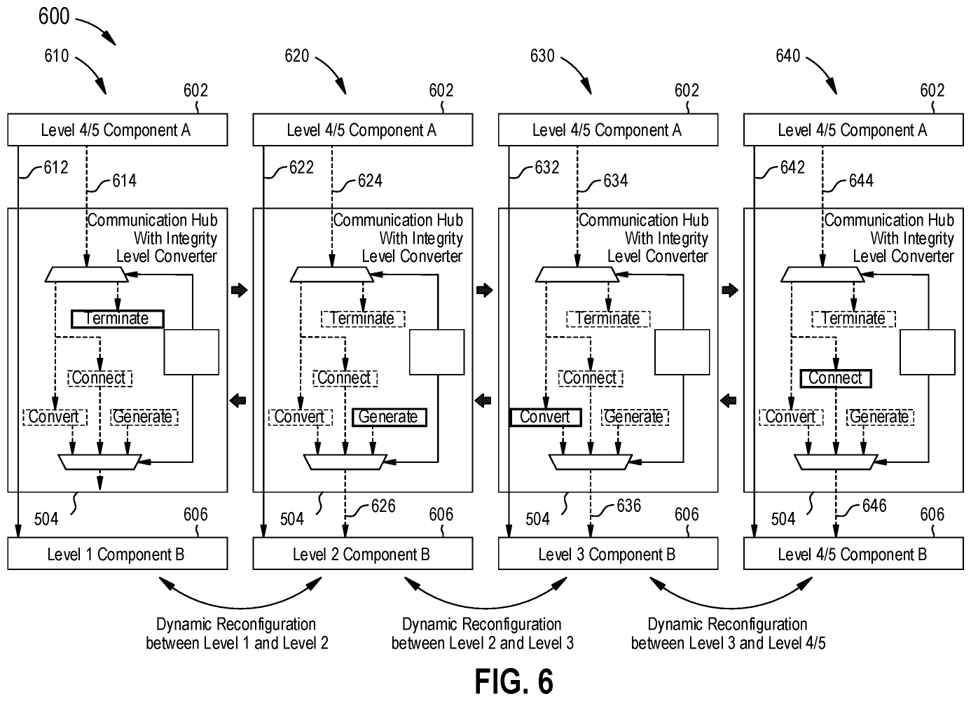

FIG. 6 shows example operations 600 by the integrity level converter 504 and Component B 606, facilitating communications including adaptive integrity levels between a Component A 602 and a Component B 606, in accordance with an example of the present disclosure. At each of states 610, 620, 630, and 640, Component A 602 operates at either integrity level 4 or integrity level 5, whereas Component B 606 changes its integrity levels in transitioning between states. In other words, Component A may represent a fixed integrity level component (or an adaptive integrity level component that is maintaining its integrity level), whereas Component B may represent an adaptive integrity level component.

For example, in state 610, Component B is operating at integrity level 1, and the integrity level converter 504 selects to terminate integrity attributes 614 from Component A 602 while delivering data 612 from Component A 602 to Component B 606. In state 620, Component B is operating at integrity level 2, and the integrity level converter 504 selects to generate integrity attributes 626 based on the data 622 and delivers the generated integrity attributes 626 and data 622 to Component B 606. Integrity attributes 624 from Component A, if any, may be ignored by the integrity level converter 504. In state 630, Component B is operating at integrity level 3, and the integrity level converter 504 selects to convert integrity attributes 634 from Component A 602 into integrity attributes 636. The integrity level converter 504 then delivers the integrity attributes 636 and the data 632 to Component B 606. At 640, Component B is operating at integrity level 4 or 5, and the integrity level converter 504 selects to connect integrity attributes 644 from Component A 602 to integrity attributes 646. The integrity level converter 504 then delivers integrity attributes 646 and data 642 to Component B 606.

While FIG. 6 depicts Component B 606 transitioning from integrity level 1 to integrity level 4 or 5 in a step-like manner, examples of the present disclosure are not so limited. Component B 606 may transition directly from any integrity level to any other integrity level, and integrity level converter 504 may likewise transition from operating in any one of the states 610, 620, 630, and 640 directly to operating in any other one of the states 610, 620, 630, and 640, corresponding to the contemporary integrity level of Component B, simply by changing the integrity level selected by the integrity level select function 510.

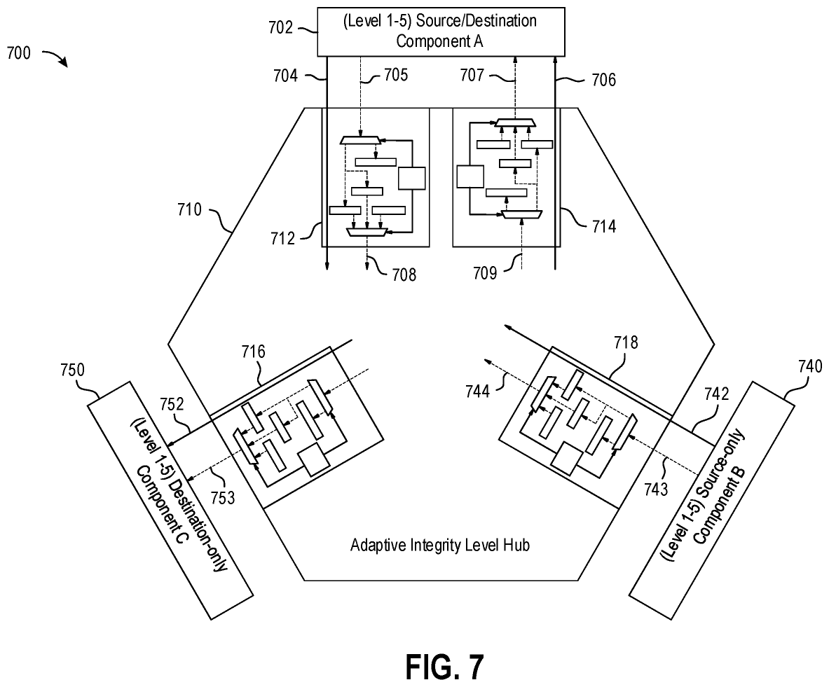

FIG. 7 shows an example system 700 including an example adaptive integrity level hub 710, in accordance with an example of the present disclosure. The example system 700 includes a Component A 702, a Component B 740, and a Component C 750. Each of Component A 702, Component B 740, and Component C 750 is capable of operating at any of integrity levels 1-5. In this example, Component A 702 may act as both a source and destination for data, Component B 740 may act as only a source for data, and Component C 750 may act as only a destination for data. As such, the adaptive integrity level hub 710 may include four integrity level converters 712, 714, 716, and 718, which may be examples of the integrity level converter 504 described with reference to FIGS. 5 and 6.

Two integrity level converters 712 and 714 are configured to communicate with Component A 702. Integrity level converter 712 is configured to receive data 704 and integrity attributes 705 from Component A 702. Integrity level converter 714 is configured to send data 706 and integrity attributes 707 to Component A 702.

Because Component B 740 can act only as a source for data, one integrity level converter 718 is configured to communicate with Component B 740 in this example. Integrity level converter 718 is configured to receive data 742 and integrity attributes 743 from Component B 740.

Because Component C 750 can act only as a destination for data, one integrity level converter 716 is configured to communicate with Component C 750 in this example. Integrity level converter 716 is configured to send data 752 and integrity attributes 753 to Component C 750.

The adaptive integrity level hub 710 further comprises routing logic and switching facilities enabling the integrity level converters 712 and 718 to connect to Component C 750. When integrity level converter 712 is connected to Component C 750, integrity level converter 712 delivers data 704 and integrity attributes 708 to Component C 750 as data 752 and integrity attributes 753, respectively. When integrity level converter 718 is connected to Component C 750, integrity level converter 718 delivers data 742 and integrity attributes 744 to Component C 750 as data 752 and integrity attributes 753, respectively. The adaptive integrity level hub 710 further comprises routing logic and switching facilities enabling the integrity level converter 718 to connect to Component A 702. When integrity level converter 718 is connected to Component A 702, integrity level converter 718 delivers data 742 and integrity attributes 744 to Component A 702 as data 706 and integrity attributes 707, respectively. The adaptive integrity level hub 710 further comprises routing logic and switching facilities enabling the integrity level converter 714 to connect to Component B 740. When integrity level converter 714 is connected to Component B 740, integrity level converter 714 may receive data 742 and integrity attributes 743 from Component B 702 as data 706 and integrity attributes 709, respectively. The adaptive integrity level hub 710 may further comprise routing logic and switching facilities enabling the integrity level converters 712, 714, 716, and 718 to connect to other components which are not shown.

The table below illustrates example integrity class settings for heterogeneous integrity class components exchanging information via the adaptive integrity level hub 710, with reference to FIG. 7.

| | | Communication | Integrity |
|---|---|---|---|
| Entry | Communication Initiator | Target | class |
| 1 | Component A 702 | Adaptive integrity | Mode |
| | | level hub 710 | |
| 2 | Adaptive integrity | Component A 702 | Mode |
| | level hub 710 | | |
| 3 | Component B 740 | Component A 702 | Mode |
| | configured to operate at | | |
| | integrity level 5 only | | |
| 4 | Component B 740 | Component C 750 | Convert |
| | configured to operate at | configured to operate at | |
| | integrity level 5 only | integrity level 3 only | |
| 5 | Component A 702 | Component C 750 | Connect |
| | operating at integrity | configured to operate at | |
| | level 3 | integrity level 3 only | |
| 6 | Component B 740 | Component A 702 | Convert or |
| | configured to operate at | operating at integrity | Terminate |
| | integrity level 5 only | level 3 | |

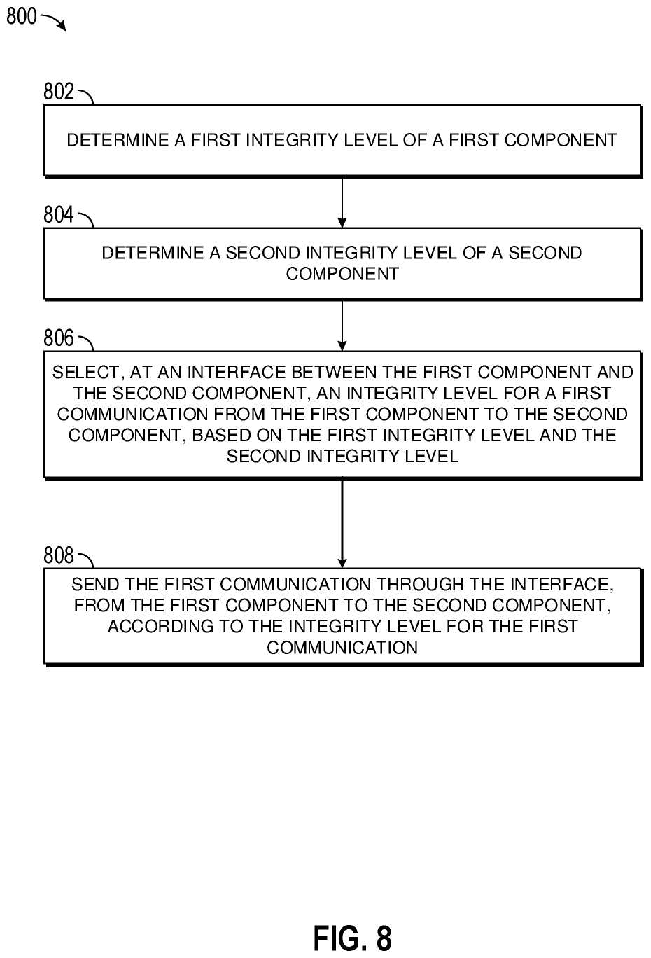

FIG. 8 depicts a flow diagram of example operations 800 for communication. The operations 800 may be performed by components in a communications system, such as the automobile 100 and systems 200 and 300 of FIGS. 1, 2, and 3, respectively, in accordance with an example of the present disclosure. The flow diagram includes blocks representing the operations 800.

The operations 800 may begin, at block 802, by determining a first integrity level of a first component. In some examples, this corresponds to determining an integrity level of one of the ultrasonic sensors 102a-102h, thermal/infrared camera 104, laser radar 106, cameras 108a-108g, and short-range radars 110a-110e, shown in FIG. 1. In other examples, this corresponds to determining an integrity level of a central DA module 120 or a vehicle control module 130, shown in FIG. 1. In yet other examples, this corresponds to determining an integrity level of a component 202, 302, 402, 404, 422, 424, 442, 444, 462, 464, 502, 602, 702, or 740, shown in FIGS. 2-7.

The operations 800 continue, at block 804, by determining a second integrity level of a second component. In some examples, this corresponds to determining an integrity level of a central DA module 120 or a vehicle control module 130, shown in FIG. 1. In other examples, this corresponds to determining an integrity level of a component 220, 320, 402, 404, 422, 424, 442, 444, 462, 464, 506, 606, 702, or 750, shown in FIGS. 2-7.

The operations 800 continue, at block 806, by selecting, at an interface between the first component and the second component, an integrity level for a first communication from the first component to the second component, based on the first integrity level and the second integrity level. In some examples, this corresponds to selecting an integrity level or an integrity class, such as those described herein, at one of the integrity level converters 410, 504, 712, 714, 716, or 718, shown in FIGS. 4-7.

The operations 800 continue, at block 808, by sending the first communication through the interface, from the first component to the second component, according to the integrity level for the first communication. In some examples, this corresponds to sending data through one of the integrity level converters 410, 504, 712, 714, 716, or 718, shown in FIGS. 4-7, while optionally receiving integrity attributes from the first component and optionally transmitting integrity attributes to the second component according to a selected integrity class, as described herein.

According to some examples, the operations 800 further include determining that at least one of the first integrity level or the second integrity level has changed. In this case, the operations 800 may further involve selecting, at the interface (e.g., with the integrity level select function 510), an integrity level for a second communication from the first component to the second component. Then, the second communication may be sent through the interface, from the first component to the second component, according to the integrity level for the second communication. For some examples, the integrity level for the second communication is lower than the integrity level for the first communication. In this case, the operations 800 may further involve controlling reallocation of one or more resources of the first component based on the selection of the integrity level for the second communication. For other examples, the integrity level for the second communication is higher than the integrity level for the first communication. In this case, the operations 800 may further include controlling allocation of one or more resources of the first component based on the selection of the integrity level for the second communication.

According to some examples, the first integrity level of the first component differs from the second integrity level of the second component, where the first component has a subset or a different set of a plurality of integrity capabilities associated with the second component. In this case, the operations 800 may further include converting integrity attributes for the first communication from the first component to the second component, such that for the first communication, a first integrity level of the first component effectively matches a second integrity level of the second component.

According to some examples, the first integrity level of the first component is lower than the second integrity level of the second component such that integrity capabilities associated with the second component are not available for the first component. In this case, the operations 800 may further involve generating integrity attributes for the first communication from the first component to the second component, such that for the first communication, the first integrity level of the first component effectively matches the second integrity level of the second component.

According to some examples, the first integrity level of the first component is higher than the second integrity level of the second component such that integrity capabilities associated with the first component are not available for the second component. In this case, the operations 800 may further include terminating integrity attributes for the first communication from the first component to the second component, such that for the first communication, the first integrity level of the first component effectively matches the second integrity level of the second component.

In the preceding, reference is made to examples presented in this disclosure. However, the scope of the present disclosure is not limited to specific described examples. Instead, any combination of the described features and elements, whether related to different examples or not, is contemplated to implement and practice contemplated examples. Furthermore, although examples disclosed herein may achieve advantages over other possible solutions or over the prior art, whether or not a particular advantage is achieved by a given example is not limiting of the scope of the present disclosure. Thus, the preceding aspects, features, embodiments, and advantages are merely illustrative and are not considered elements or limitations of the attached claims except where explicitly recited in one or more of the claims.

As will be appreciated by one skilled in the art, the examples disclosed herein may be embodied as a system, method, or apparatus, and the like. Accordingly, examples may take the form of an entirely hardware embodiment or a combination of hardware products or an embodiment combining hardware aspects with corresponding programming that may all generally be referred to herein as a “circuitry” or “system.” Furthermore, certain aspects, such as programmable logic blocks, lookup tables (LUTs), and the like, may take the form of hardware components that can be controlled using corresponding programming.

Any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the context of this document, a computer-readable storage medium is any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electrical, magnetic, optical, electromagnetic, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless (e.g., radio frequency (RF) or infrared), wireline, optical fiber or cable, etc., or any suitable combination of the foregoing.

Computer program code for carrying out operations or programming for examples of the present disclosure may be written in any combination of one or more programming languages, including an object oriented programming language such as Java, Smalltalk, C++ or the like and procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Examples of the present disclosure are described herein with reference to flowchart illustrations and/or block diagrams of methods, apparatus (e.g., systems), and computer program products presented herein. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer-implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and apparatus according to various examples of the present disclosure. In this regard, each block in the flowchart or block diagrams may represent circuitry, programming for such circuitry, or portion of instructions for such circuitry, which comprises one or more executable instructions for controlling or programming the circuitry to perform the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

1. An interface for communication between a first component and a second component, the interface comprising logic configured to change an integrity level for a communication from the first component to the second component during operation of the first component and the second component.

2. The interface of claim 1, wherein the integrity level for the communication comprises at least one of a safety level or a security level.

3. The interface of claim 1, wherein the logic is configured to change the integrity level for the communication from a higher integrity level to a lower integrity level and wherein the logic is further configured to control reallocation of one or more resources of the first component based on the change to the lower integrity level.

4. The interface of claim 1, wherein the logic is configured to change the integrity level for the communication from a lower integrity level to a higher integrity level and wherein the logic is further configured to control allocation of one or more resources of the first component based on the change to the higher integrity level.

5. The interface of claim 1, wherein at least one of the first component or the second component has an adaptive integrity level capable of being changed programmatically.

6. The interface of claim 1, wherein one of the first component or the second component has an adaptive integrity level capable of being changed programmatically and wherein the other one of the first component or the second component has a fixed integrity level.

7. The interface of claim 1, wherein a portion of the interface is located in the first component and wherein another portion of the interface is located in the second component.

8. The interface of claim 1, wherein:
the first component has a subset or a different set of a plurality of integrity capabilities associated with the second component; and
the logic is configured to convert integrity attributes for the communication from the first component to the second component, such that for the communication, a first integrity level of the first component effectively matches a second integrity level of the second component.

9. The interface of claim 1, wherein:
a first integrity level of the first component is lower than a second integrity level of the second component such that integrity capabilities associated with the second component are not available for the first component; and
the logic is configured to generate integrity attributes for the communication from the first component to the second component, such that for the communication, the first integrity level of the first component effectively matches the second integrity level of the second component.

10. The interface of claim 1, wherein:
a first integrity level of the first component is higher than a second integrity level of the second component such that integrity capabilities associated with the first component are not available for the second component; and
the logic is configured to terminate integrity attributes for the communication from the first component to the second component, such that for the communication, the first integrity level of the first component effectively matches the second integrity level of the second component.

11. The interface of claim 1, wherein the logic is configured to change the integrity level based on at least one requirement of an application that changes with at least one of time or space.

12. The interface of claim 1, wherein:
a first integrity level of the first component differs from a second integrity level of the second component; and
the logic is further configured to change another integrity level for another communication from the second component to the first component during operation of the first component and the second component, such that for the other communication, the second integrity level of the second component effectively matches the first integrity level of the first component.

13. The interface of claim 1, further comprising:
a main signal path for routing the communication from the first component to the second component; and
an integrity path for routing integrity attributes from the first component to the second component, wherein the logic is configured to change the integrity level of the communication by controlling the integrity path.

14. An integrated circuit (IC) comprising the interface of claim 1, the IC further comprising:
the first component coupled to the interface; and
the second component coupled to the interface, wherein the interface comprises a communication hub.

15. A method of communication, comprising:
determining a first integrity level of a first component;
determining a second integrity level of a second component;
selecting, at an interface between the first component and the second component, an integrity level for a first communication from the first component to the second component, based on the first integrity level and the second integrity level; and
sending the first communication through the interface, from the first component to the second component, according to the integrity level for the first communication.

16. The method of claim 15, further comprising:
determining that at least one of the first integrity level or the second integrity level has changed;
selecting, at the interface, an integrity level for a second communication from the first component to the second component; and
sending the second communication through the interface, from the first component to the second component, according to the integrity level for the second communication.

17. The method of claim 16, wherein:
the integrity level for the second communication is lower than the integrity level for the first communication; and
the method further comprises controlling reallocation of one or more resources of the first component based on the selection of the integrity level for the second communication.

18. The method of claim 15, wherein:
the first integrity level of the first component differs from the second integrity level of the second component;
the first component has a subset or a different set of a plurality of integrity capabilities associated with the second component; and
the method further comprises converting integrity attributes for the first communication from the first component to the second component, such that for the first communication, a first integrity level of the first component effectively matches a second integrity level of the second component.

19. The method of claim 15, wherein:
the first integrity level of the first component is lower than the second integrity level of the second component such that integrity capabilities associated with the second component are not available for the first component; and
the method further comprises generating integrity attributes for the first communication from the first component to the second component, such that for the first communication, the first integrity level of the first component effectively matches the second integrity level of the second component.

20. The method of claim 15, wherein:
the first integrity level of the first component is higher than the second integrity level of the second component such that integrity capabilities associated with the first component are not available for the second component; and
the method further comprises terminating integrity attributes for the first communication from the first component to the second component, such that for the first communication, the first integrity level of the first component effectively matches the second integrity level of the second component.
